(19) United States
(12) Patent Application Publication
(10) Pub. No.: US 2025/0321330 A1
(43) Pub. Date: Oct. 16, 2025

(54) Loading surface monitoring device, vehicle and method for monitoring a loading surface of a vehicle

(71) Applicant: ETO MAGNETIC GmbH, Stockach (DE)

(72) Inventors: Benjamin Bönisch, Bodman-Ludwigshafen (DE); Tobias Plötzing, Bodman-Ludwigshafen (DE)

(21) Appl. No.: 18/573,060

(22) PCT Filed: Jun. 30, 2022
(86) PCT No.: PCT/EP2022/068069

§ 371 Date: Jun. 19, 2024

(30) Foreign Application Priority Data
Jul. 2, 2021 (DE) 10 2021 117 190.3

(51) Int. Cl. G01S 13/04; G01S 13/58; G01S 13/86; G01S 13/931

(52) U.S. Cl. CPC G01S 13/04; G01S 13/58; G01S 13/86; G01S 13/931

(57) ABSTRACT

A loading surface monitoring device comprising at least one radar and/or lidar sensor unit configured for installation on a vehicle and/or on a container and configured for monitoring a vehicle loading surface and/or a container loading surface.

### CROSS-REFERENCE TO RELATED APPLICATIONS

This patent application is a U.S. national stage application of international patent application PCT/EP2022/068069, filed on Jun. 30, 2022, which is based on and claims priority to German patent application DE 10 2021 117 190.3, filed on Jul. 2, 2021, the contents of which are incorporated herein by reference.

### PRIOR ART

The invention relates to a loading surface monitoring device, a vehicle and a method.

It has already been proposed to monitor vehicles and their loads by means of cameras and/or microphones.

The object of the invention is in particular to provide a generic device with advantageous properties with regard to loading surface monitoring. The object is achieved according to the invention.

### Advantages of the Invention

A loading surface monitoring device is proposed, comprising at least one radar and/or lidar sensor unit configured for installation on a vehicle and/or a container and configured for monitoring a vehicle loading surface and/or a container loading surface. Advantageous properties with regard to monitoring of loading surfaces of vehicles and containers can thereby be achieved. In particular in comparison to light-sensitive cameras, reliable monitoring can also take place in the case of severe darkness, e.g. in closed containers or loading spaces. In addition, particularly thorough monitoring can advantageously be achieved, in which even small changes within the loading surface, e.g. small load slippages or the like, or small movable objects or animals, such as e.g. mice, can be reliably detected. In addition, an at least rough estimation of a still available loading space on the loading surface can advantageously be made possible. Furthermore, damage to a wall delimiting the loading space of the loading surface, e.g. in the event of a break-in, can advantageously be detected. In particular, the loading surface monitoring device is configured for radar monitoring and/or for lidar monitoring of the vehicle loading surface and/or the container loading surface. In particular, the loading surface monitoring device is fixedly installed within a loading space formed by the vehicle loading surface and/or the container loading surface. In particular, the loading surface monitoring device comprises at least one fastening device by means of which the loading surface monitoring device can be fastened in the loading space of the vehicle or container. In addition, it is also conceivable that the loading surface monitoring device is used with an open loading surface (e.g. a dump truck or the like). The monitoring sensors, in particular the ultra-wideband radar sensors, are fastened for example to a towing vehicle towing the trailer with the open loading surface or to a driver's cab of a vehicle comprising an open loading surface.

The vehicle is preferably designed as a truck. Alternatively, however, the vehicle can also be designed as another land vehicle, such as e.g. a train, a wagon, a transporter, a pickup truck, a farm machine, a trailer, a semi-trailer or the like. Alternatively, the vehicle can also be designed as a watercraft, e.g. a cargo ship, a container ship, a ferry, a trawler or another watercraft with a loading surface. Alternatively, the vehicle can also be designed as an aircraft, for example a cargo aircraft, an airship, a rotorcraft, such as a (transport) helicopter, a balloon, a (transport) drone or another aircraft with a loading surface. Alternatively, the vehicle can also be designed as a spacecraft, for example a rocket or a space transporter (supply ship) or another spacecraft with a loading surface. In particular, the loading surface monitoring device is configured for monitoring the vehicle loading surface and/or a container loading surface and the loading space of the vehicle or container delimited by the vehicle loading surface and/or a container loading surface. In particular, the radar and/or lidar sensor unit can also be designed as a radar sensor unit only, in particular an ultra-wideband radar sensor unit, or as a lidar sensor unit only.

It is further proposed, that the radar and/or lidar sensor unit comprises at least one ultra-wideband radar sensor. Advantageous monitoring properties can thereby be achieved. Small objects and/or changes can thereby advantageously be reliably detected. In addition, a distinction between animate and inanimate matter (on the basis of the water content contained therein), in particular between living beings and non-living objects, can advantageously be made possible. Advantageously, by using ultra-wideband radar sensor technology, influencing and/or interference with other radio transmission methods, in particular other narrowband radio transmission methods, such as LoRa, 5G or WLAN (in particular 802.11p), can additionally be prevented. In particular, the radar and/or lidar sensor unit is designed as an ultra-wideband radar sensor unit. In particular, it is also conceivable that the radar and/or lidar sensor unit comprises exclusively the ultra-wideband radar sensor and no further radar or lidar sensors.

Advantageously, the ultra-wideband radar sensor cannot be disturbed or rendered unusable in a simple manner, e.g. by sticking with an adhesive tape or hanging with a cloth or the like. In particular advantageous properties with regard to anti-theft monitoring can thereby be achieved.

It is further proposed. that the ultra-wideband radar sensor is based on M-sequence technology. A particularly precise detection of movement, in particular also at high movement speeds, of objects moved in the field of view of the sensor, preferably also at particularly small distances of the objects from the sensor, can thereby advantageously be achieved. Advantageously, M-sequence signals, in particular in comparison with (UWB) pulse signals and/or with sine signals, are less noisy. Advantageously, M-sequence signals, in particular in comparison with (UWB) pulse signals and/or with sine signals, are less susceptible to interference. Advantageously, M-sequence signals, in particular in comparison with (UWB) pulse signals and/or with sine signals, cause little interference with other applications, for example narrowband radio applications such as LoRa, 5G or WLAN (in particular 802.11p). Advantageously, M-sequence signals, in particular in comparison with (UWB) pulse signals and/or with sine signals, are only slightly influenced and/or interfered with by signals of other radio sources, for example narrowband radio applications such as LoRa, 5G or WLAN (in particular 802.11p). Advantageously, the M-sequence signals make a simultaneous measurement over an entire (UWB) frequency range of the sensors possible, so that several thousand measurements per second can be made possible. An “M-sequence” is to be understood in particular as a pseudo-random, binary sequence known under the technical terms “maximum length sequence” or a “sequence of maximum length”. In particular, the M-sequence represents a pseudo-noise sequence. In particular, the M-sequence has a flat frequency spectrum, which preferably resembles white noise. In particular, the ultra-wideband sensor is configured to generate and emit a signal, in particular a pseudo-noise signal, based on the M-sequence and/or formed by an M-sequence. In particular, the M-sequence signal can be generated by means of feedback shift registers. In particular, the sensor module comprises at least one circuit for generating the M-sequence, which preferably comprises an N-stage shift register for generating the M-sequence. In particular, the ultra-wideband radar sensor comprises a transmitting unit, which generates and emits an M-sequence transmission signal. In particular, the electromagnetic waves emitted by the ultra-wideband radar sensor form the M-sequence transmission signal. Preferably, a determination of the phase relationships of the plurality of electromagnetic waves of different frequencies emitted by the ultra-wideband sensor, in particular of the wave packet, determines whether the emitted transmission signal is an impulsive signal or whether it forms an M-sequence in the time domain. In particular, the ultra-wideband radar sensor comprises a receiving unit, which receives portions of the M-sequence transmission signal reflected by an object or by a living being. In particular, the ultra-wideband radar sensor comprises an evaluation unit, which evaluates the received reflected M-sequence transmission signal and determines therefrom at least a distance of the reflecting object and/or, on the basis of a determination of the water content of the object, makes an estimation as to whether the object is a living being or not. Advantageously, the measurement and the measurement result of the ultra-wideband radar sensor with the M-sequence technology is at least substantially unaffected by grease, dirt and/or ice layers as well as by rain and/or fog in the region of a measurement path of the ultra-wideband sensor.

It is further proposed, that the ultra-wideband radar sensor operates in a frequency range between 100 MHz and 6 GHz with a bandwidth of at least 500 MHz, preferably at least 1 GHz, preferably at least 2 GHz, more preferably at least 4 GHz and particularly preferably of at least 5.5 GHZ, and/or in a frequency range between 6 GHz and 8.5 GHz with a bandwidth of at least 500 MHZ, preferably at least 1 GHz, preferably at least 1.5 GHZ, more preferably at least 2 GHz and particularly preferably of at least 2.5 GHz. As a result, interference, in particular mutual interference, by further radio sources such as LoRa, 5G or WLAN (in particular 802.11p) can advantageously be avoided. A particularly high spatial resolution and/or a particularly low minimum measurement distance can advantageously be achieved, in particular by the high bandwidth of the frequency range between 6 GHz and 8.5 GHz, in particular also because no high pulse powers, which override a receiver, are emitted. In addition, advantageously no radio licenses are required for these frequency ranges, in particular if a transmission power is within a range of −41.3 dBm/MHz. The transmission power of the ultra-wideband radar sensor is preferably −41.3 dbm/MHz or less. In particular, the frequency band between 100 MHz and 6 GHz and/or the frequency band between 6 GHz and 8.5 GHz is configured at least for distance measurement, in particular also in the vicinity of the ultra-wideband radar sensor. In particular, it is conceivable that the sensor module, in particular the sensor or at least two sensors of the sensor module, measures and/or is operated at least partially simultaneously or alternately in both frequency bands (100 MHz to 6 GHz and 6 GHz to 8.5 GHZ).

If the ultra-wideband radar sensor is configured for a detection of living beings, in particular humans and/or animals, in the area of the vehicle loading surface and/or the container loading surface, improved loading surface monitoring can advantageously be achieved. Advantageously, detection of pests, such as mice, birds, etc., detection of unauthorized persons, e.g. blind passengers, etc., and/or detection of intruders can be made possible and/or improved. In particular, living beings above a minimum size of approximately 1 cm, preferably approximately 3 cm, can be detected. In particular, individual insects cannot be detected, but larger accumulations of insects, such as e.g. termites. Maggots or beetle larvae in an object (e.g. wood, food, etc.) or the like are conceivable. In particular, the detection of living beings is based on a detection of a water content of an object, a movement of an object or a combination of water content and movement of the object.

If the ultra-wideband radar sensor is configured for a detection of movements of objects, for example loaded goods, located on the vehicle loading surface and/or the container loading surface, a load slippage or improper storage of objects can advantageously be detected early. Damage to the load, vehicle and/or container can thereby advantageously be prevented. In addition, safety can advantageously be increased, for example by a driver of a vehicle being informed directly about the detected state. In particular, the detection of movements of objects is based on a direct detection of an acceleration of an object and/or on a comparison of object positions between repeated measurements, in particular ultra-wideband radar pulses.

If the ultra-wideband radar sensor is configured for a detection of changes in the side walls delimiting the vehicle loading surface and/or the container loading surface, for example for a detection of the occurrence of a new opening in at least one side wall, advantageous properties with regard to anti-theft can be achieved. For example, the ultra-wideband radar sensor is configured for a detection of a slashing of truck loading side walls. Such a slashing of the truck loading side walls represents one of the most frequently occurring break-in methods in trucks and can advantageously be reliably detected by the present invention, so that countermeasures can be initiated promptly. In particular, the ultra-wideband radar sensor is configured for a detection of a slashing of a tarpaulin forming a loading side wall. In particular, the ultra-wideband radar sensor is configured for a detection of an unauthorized reduction of a load on the vehicle loading surface and/or the container loading surface. In particular, the ultra-wideband radar sensor is configured for a detection of an enlargement of a free surface of the vehicle loading surface and/or the container loading surface. In particular, the detection of movements of objects is based on a direct detection of a break-in into the vehicle and/or the container, on a monitoring of a state of the loading side walls, on a comparison of a reduction of a load with a (vehicle-internal or vehicle-external) database, from which an intended load quantity can be retrieved, and/or on a monitoring of the available free surfaces.

If the ultra-wideband radar sensor is configured for a detection of free loading surface areas and preferably supplies an approximate surface indication of the free loading surface areas, a particularly efficient loading/loading surface utilization can advantageously be achieved. In particular, it is conceivable that determined free loading surfaces are offered directly on a marketplace, in particular with available free surface and free weight information. In particular, it is conceivable that for determining a free weight information, the loading surface data determined by the ultra-wideband radar sensor are compared with a loading list of the currently loaded load comprising load information, such as weight, etc.

In this context, it is conceivable that a free loading surface is indicated to a driver of the vehicle and/or to a loader or unloader of the vehicle by an output and/or display of a loading surface number or by a lighting of a lighting element integrated into the loading surface or applied onto the loading surface. In particular, the loading and/or unloading process can be monitored and/or a storage location of goods can be stored, e.g., by the vehicle or by a mobile device. During unloading, the unloader of the vehicle could then select the respective goods sought (e.g., via a mobile device or a control device of the vehicle), whereupon the associated position in the loading surface is displayed by the respective lighting element. Thus, the driver or the loader or unloader saves time and does not long search for the desired goods.

In addition, it is proposed that the loading surface monitoring device comprises a computing unit which is configured to evaluate measurement data of the ultra-wideband radar sensor for a detection of living beings, for a detection of movement of goods, for a detection of side wall manipulation and/or for a detection of free surfaces and in particular to generate corresponding messages and/or warning notifications. An effective monitoring can thereby advantageously be made possible, which in particular makes a prompt counteraction possible. In particular, the radar and/or lidar sensor unit is configured to output a message and/or a warning notification to a receiver, for example a driver of the vehicle, to a shipping company or to an owner of the load when detecting living beings. In this case, it is conceivable that the messages and/or warning notifications comprise information about the type of detected living being (small animal, large animal, human, number of humans, etc.). Accidents, in which people, for example migrants, who are hiding in vehicles or containers, come to damage, can thereby advantageously be prevented. In particular, the radar and/or lidar sensor unit is configured to output a message and/or a warning notification to a receiver, for example a driver of the vehicle, to a shipping company or to an owner of the load when detecting movements of goods. In this case, it is conceivable that the messages and/or warning notifications comprise information about the extent of the movement of goods. In addition, it is conceivable that the notification function or the warning function is deactivated during a planned unloading or loading of the vehicle loading surface and/or a container loading surface. In particular, the radar and/or lidar sensor unit is configured to output a theft warning notification to a receiver, for example a driver of the vehicle, to a shipping company or to an owner of the load when detecting side wall manipulations. In particular, the radar and/or lidar sensor unit is configured to output a message about available free surfaces and free weights to a receiver, for example a driver of the vehicle, to a shipping company or to an owner of the load when detecting free surfaces. As a result, the receiver, e.g. the driver, can quickly decide whether to accept or reject an additional order.

If the loading surface monitoring device comprises at least one load weight sensor, a direct and/or exact determination of the free weight can advantageously be achieved. For example, the load weight sensor can be designed as a weighing system integrated into an axle of the vehicle.

It is further proposed that the radar and/or lidar sensor unit comprises a communication module, in particular a wireless or wired communication module, which is configured at least to output measurement data of the radar and/or lidar sensor unit, in particular of the ultra-wideband radar sensor, and/or notifications determined based on the measurement data of the radar and/or lidar sensor unit, in particular of the ultra-wideband radar sensor, to an external receiver, in particular to an external receiving and/or playback device. A high user-friendliness can thereby advantageously be achieved. It is conceivable that the communication module establishes a cable connection into a cockpit/driver's cabin/control room of the vehicle. In particular in the case of towing vehicle-trailer combinations, such as e.g. semitrailers, however, a radio connection to the cockpit/driver's cabin/control room of the vehicle can be advantageous, since a cable connection does not then have to be established or disconnected each time the trailer is hitched or unhitched. For wireless communication, various known short-range (e.g. WLAN, Bluetooth, etc.) or long-range (e.g. mobile radio) wireless communication protocols are possible. The external receiving and/or playback device can be designed as a separate human-machine interface (HMI), such as e.g. a specially programmed tablet, specifically provided for communication with the radar and/or lidar sensor unit. Alternatively, the external receiving and/or playback device can also be integrated into an existing system, such as e.g. a navigation device, a smartphone or an on-board computer of a vehicle or the like. In particular, an external navigation device, a navigation device integrated into a vehicle, a smartphone of a vehicle driver or an on-board computer of a vehicle or the like can form the receiving and/or playback device. Alternatively or additionally, it is conceivable, in particular in the case of autonomously driving vehicles, that the loading surface monitoring device comprises a machine-machine interface (MMI) which is configured in particular to set up a connection to the Internet and independently performs decentralized processing or evaluation of the measurement data of the radar and/or lidar sensor unit, in particular of the ultra-wideband radar sensor. For example, in this case, independently decentralized transport orders based on the measurement data of the radar and/or lidar sensor unit can be accepted or rejected.

If a field of view of the radar and/or lidar sensor unit, in particular of the ultra-wideband radar sensor, is oriented from above onto the vehicle loading surface and/or the container loading surface, an advantageously good overview of the loading surface can be ensured. An “above view” is to be understood in particular as a view obliquely or perpendicularly from above onto an area, in particular the vehicle loading surface or the container loading surface. In particular, a visual axis/a field of view center of the field of view of the optical sensor unit is inclined at most by 75°, preferably at most by 60° and preferably at most by 45° and particularly preferably at most by 30° with respect to the vertical (with respect to the vehicle loading surface or the container loading surface) in the intended operating and/or installation state of the optical sensor unit. Preferably, the ultra-wideband radar sensor is arranged and/or installed in the region of a loading space ceiling delimiting a loading space or an upper end of a side wall delimiting a loading space.

It is further proposed that the radar and/or lidar sensor unit comprises at least two, preferably at least four, ultra-wideband radar sensors, which are preferably formed realized from one another and arranged spaced apart from one another. A particularly reliable and/or precise loading surface monitoring can thereby advantageously be enabled.

If a field of view of a first ultra-wideband radar sensor of the radar and/or lidar sensor unit is oriented at least substantially opposed to a field of view of a second ultra-wideband radar sensor of the radar and/or lidar sensor unit, a particularly comprehensive monitoring of the vehicle loading surface and/or the container loading surface can advantageously be made possible.

If at least four ultra-wideband radar sensors of the radar and/or lidar sensor unit are arranged relative to the vehicle loading surface and/or to the container loading surface in such a way that a connecting line connecting the four ultra-wideband radar sensors, in particular the shortest and not self-intersecting, forms an, in particular at least substantially flat, rectangle, a particularly comprehensive monitoring of the vehicle loading surface and/or the container loading surface can advantageously be enabled. In particular, in each case at least one ultra-wideband radar sensor is arranged and/or installed in all four corners of an approximately cuboid loading space of the vehicle loading surface and/or the container loading surface.

Alternatively or additionally, it is proposed that at least one monitoring sensor of the radar and/or lidar sensor unit, in particular of the ultra-wideband radar sensor, is supported movably, in particular translationally movably and/or pivotably, within the loading space of the vehicle loading surface and/or the container loading surface. A particularly comprehensive and/or reliable monitoring of the vehicle loading surface and/or of the container loading surface can thereby advantageously be enabled, in particular in the case of a possibly smallest total number of monitoring sensors. For example, it is conceivable that the radar and/or lidar sensor unit comprises (only) one monitoring sensor, in particular ultra-wideband radar sensor, which is movable along a rail, which preferably extends along a loading space ceiling of the loading space of the vehicle loading surface and/or the container loading surface. In addition, this monitoring sensor movable along the rail, in particular ultra-wideband radar sensor, could be designed pivotable, for example, about a pivot axis, which extends parallel to the rail. In this case, the rail could extend centrally in the longitudinal direction along the loading space ceiling of the loading space of the vehicle loading surface and/or the container loading surface and the monitoring sensor, in particular ultra-wideband radar sensor, could be pivotable in both directions relative to the vertical. Alternatively, it is also conceivable, inter alia, that two rails extending parallel to one another are arranged in edge regions of the, preferably approximately cuboid, loading space of the vehicle loading surface and/or the container loading surface, along which in each case a separate monitoring sensor, in particular ultra-wideband radar sensor, runs.

Furthermore, a vehicle, in particular a goods wagon or truck, preferably an autonomously driving truck, with an, in particular open or closed, vehicle loading surface or with a container forming a closed container loading surface and with the loading surface monitoring device arranged and/or installed in particular in an interior of the closed vehicle loading surface and/or the container loading surface is proposed. Advantageous properties with regard to monitoring of the vehicle loading surface and/or the container loading surface can thereby be achieved. Operation of the vehicle can advantageously be improved and/or simplified.

Furthermore, a method for monitoring a vehicle loading surface and/or a container loading surface by means of at least one monitoring sensor unit monitoring the vehicle loading surface and/or the container loading surface, preferably by means of the loading surface monitoring device, is proposed, wherein at least one detection of living beings within a loading space of the vehicle loading surface and/or the container loading surface, at least one detection of movement of goods within a loading space of the vehicle loading surface and/or the container loading surface, at least one detection of side wall manipulation of a side wall delimiting a loading space of the vehicle loading surface and/or the container loading surface and/or at least one detection of free surfaces within a loading space of the vehicle loading surface and/or the container loading surface is carried out by the monitoring sensor unit. Advantageous properties with regard to monitoring of loading surfaces of vehicles and containers can thereby be achieved. In particular, particularly thorough monitoring can advantageously be achieved.

In addition, it is proposed that the method for monitoring the vehicle loading surface and/or a container loading surface comprises at least the following method steps: i) providing the monitoring sensor unit with one or several monitoring sensors, in particular ultra-wideband radar sensors, ii) installing the monitoring sensors in or on the vehicle or container, iii) orienting a field of view of the monitoring sensors from above onto the vehicle loading surface and/or the container loading surface, iv) emitting a radar or lidar signal, in particular an ultra-wideband radar signal, v) receiving a reflection signal of the previously emitted radar or lidar signal, in particular the previously emitted ultra-wideband signal, vi) evaluating the reflection signal for detecting living beings, for detecting movement of goods, for detecting side wall manipulation and/or for detecting free surfaces, and optionally vii) transmitting a report based on the evaluation of the reflection signal to an external receiver. Advantageous properties with regard to monitoring of loading surfaces of vehicles and containers can be achieved by this method sequence.

If a transport offer and/or a free transport capacity is transmitted to the external receiver on the basis of the free surface detection, a high transport efficiency can advantageously be achieved. A resource utilization and/or a capacity utilization can thereby advantageously be optimized. In particular, the communication module or the external receiving and/or playback device is configured for communication with the external receiver. In particular, a selection and/or a reservation of free surfaces can be made by the external receiver on the basis of the transport offers and/or free transport capacities transmitted to it.

If route information associated with the vehicle or container, in particular a planned route layout with scheduling, is additionally transmitted to the external receiver, a transport efficiency can advantageously be further increased. A route optimization, in particular at least partially automated, of a route to be traveled by the vehicle can advantageously be carried out.

If a free surface reservation is additionally transmitted back to the vehicle or the container which has reported the transport offer and/or the free transport capacity, and in that a route layout and in particular a scheduling of the vehicle or of the container is adapted such that the free surface reservation can be fulfilled, a transport efficiency can advantageously be further increased. A route optimization, in particular at least partially automated, of a route to be traveled by the vehicle can advantageously be carried out. It is conceivable that the monitoring sensor unit, in particular the loading surface monitoring device, interacts and/or is connected to a navigation device of the vehicle, so that new route points produced or transmitted by current free surface reservations are taken over and/or integrated into a current navigation of the navigation device.

In particular, newly added route points are integrated into the current navigation in such a way that a modified route comprising the newly added route points is optimized with regard to a total travel time and/or with regard to an energy consumption.

It is additionally proposed that a vehicle-internal and/or container-internal alarm device and/or an external alarm device is controlled on the basis of the detection of living beings, the detection of movement of goods and/or the detection of side wall manipulation. A particularly effective loading surface monitoring can thereby advantageously be made possible. A prompt reaction to the detection of living beings, the detection of movement of goods and/or the detection of side wall manipulation can advantageously be made possible. The vehicle-internal and/or container-internal alarm device and/or the external alarm device can be configured in particular to output an optical warning signal (light, etc.) or an acoustic warning signal (siren, etc.). The external alarming device can also be designed, for example, as a mobile device, such as a mobile phone, smartphone, tablet, etc. of a supervisory person, e.g., a vehicle driver, a logistics operator (e.g., shipping company), an owner of transported goods, etc.

In addition, it is proposed that a drive of the vehicle, in particular of the autonomously driving truck, is controlled, in particular blocked or released, on the basis of the detection of living beings and/or the detection of movement of goods. A high level of safety can thereby advantageously be achieved. Advantageously, it can thereby be prevented that the, in particular autonomously driving, vehicle is climbed/hijacked by blind passengers or thieves.

Advantageously, it can thereby be prevented that the, in particular autonomously driving, vehicle moves in road traffic with a slipped, possibly insufficiently secured or unsecured load. In particular, it is proposed that, in the case of a detection of living beings within the loading space of the vehicle loading surface and/or the container loading surface and/or in the case of a detection of a slipping or a back-and-forth slipping or a strong shaking of goods loaded on the vehicle loading surface and/or the container loading surface, the drive of the, in particular autonomously driving, vehicle is controlled in such a way that a risk to persons or the road traffic is reduced or excluded. For example, a driving style or a driving speed of a vehicle already in motion is correspondingly adapted or the drive of the vehicle is even completely blocked until the risk is eliminated. For example, in the case of a detection of a load slipping or a strong shaking of a load, the autonomously driving vehicle can be switched into a particularly careful driving mode (low accelerations and speeds) and can be guided to a suitable parking space. The load can then be checked and secured on the parking space by a notified person.

It is further proposed that an image and/or sound recording is started on the basis of the detection of living beings, the detection of movement of goods and/or the detection of side wall manipulation. A high level of safety can thereby be achieved. For example, it is conceivable that a camera arranged on the vehicle or in the loading space of the vehicle loading surface and/or of the container loading surface and/or a microphone arranged on the vehicle or in the loading space of the vehicle loading surface and/or of the container loading surface is activated in the case of a positive detection of living beings, in the case of a positive detection of movement of goods and/or in the case of a positive detection of side wall manipulation and produces image or sound recordings of the registered situation, e.g. the slipped load, the thieves or the blind passengers. In particular, the image or sound recordings of the camera and/or of the microphone are sent directly to the outside, preferably streamed, so that they are secured on a database independent of the vehicle and/or so that an external person can perform a review and possibly initiate countermeasures.

The loading surface monitoring device according to the invention, the vehicle according to the invention, the container according to the invention and/or the method according to the invention shall in this case not be restricted to the application and implementation described above. In particular, for fulfilling a functionality described herein, the loading surface monitoring device according to the invention, the vehicle according to the invention, the container according to the invention and/or the method according to the invention can have a number deviating from a number of individual method steps, elements, components and units mentioned herein.

### DRAWINGS

Further advantages emerge from the following description of the figures. An exemplary embodiment of the invention is shown in the figures. The figures, the description and the claims contain numerous features in combination. The person skilled in the art will expediently also consider the features individually and combine them to form appropriate further combinations.

### It is Shown in:

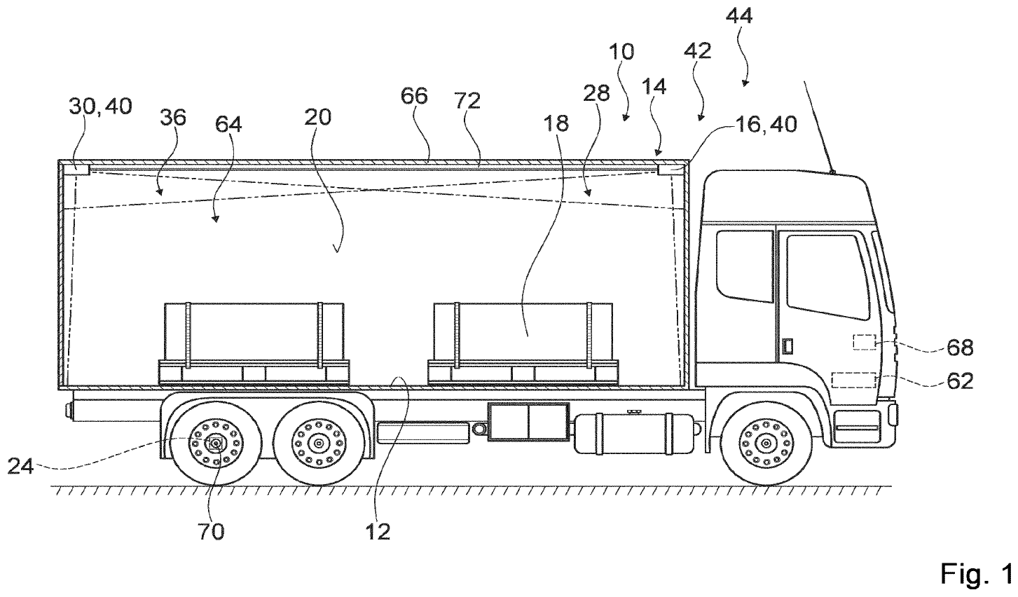

FIG. 1 a schematic side view of a vehicle with a loading surface monitoring device,

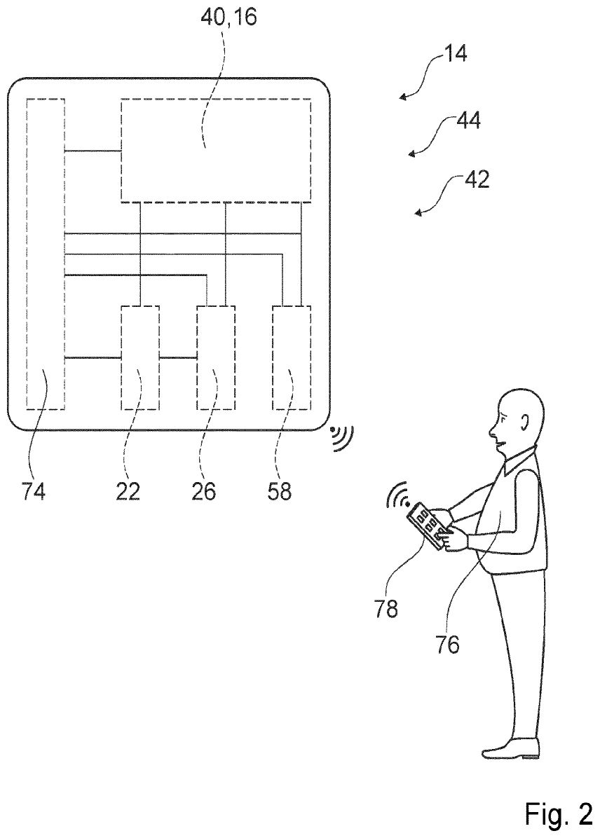

FIG. 2 a schematic representation of a portion of the loading surface monitoring device with a monitoring sensor,

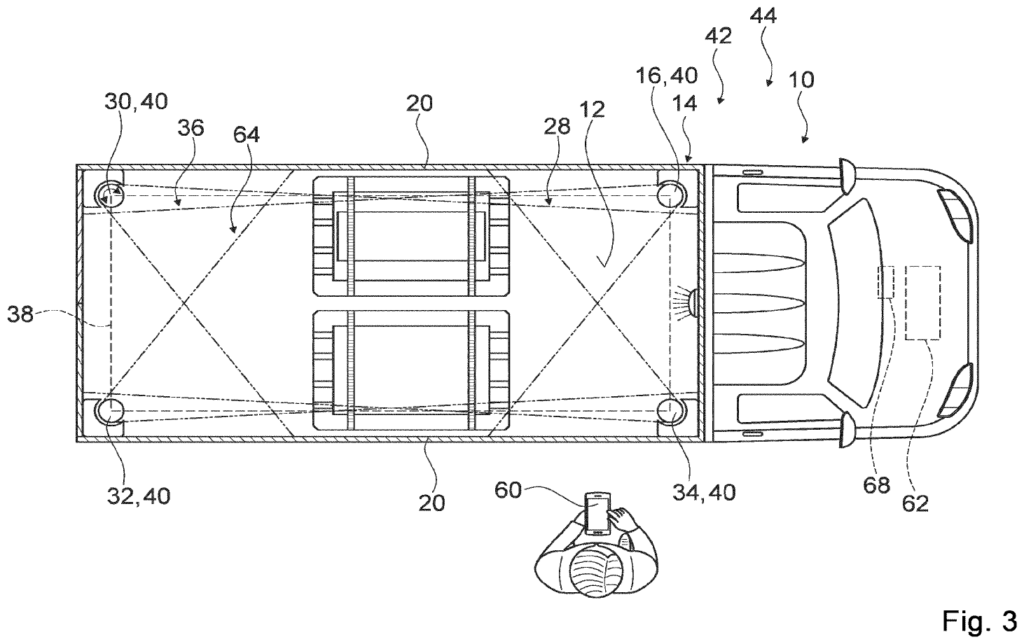

FIG. 3 a schematic plan view of the vehicle with the loading surface monitoring device,

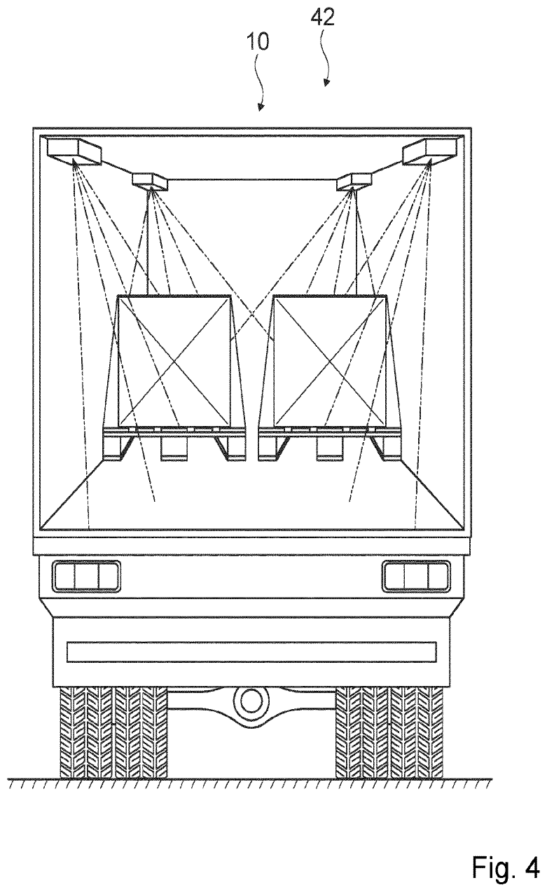

FIG. 4 a schematic rear view of the vehicle with the loading surface monitoring device, and

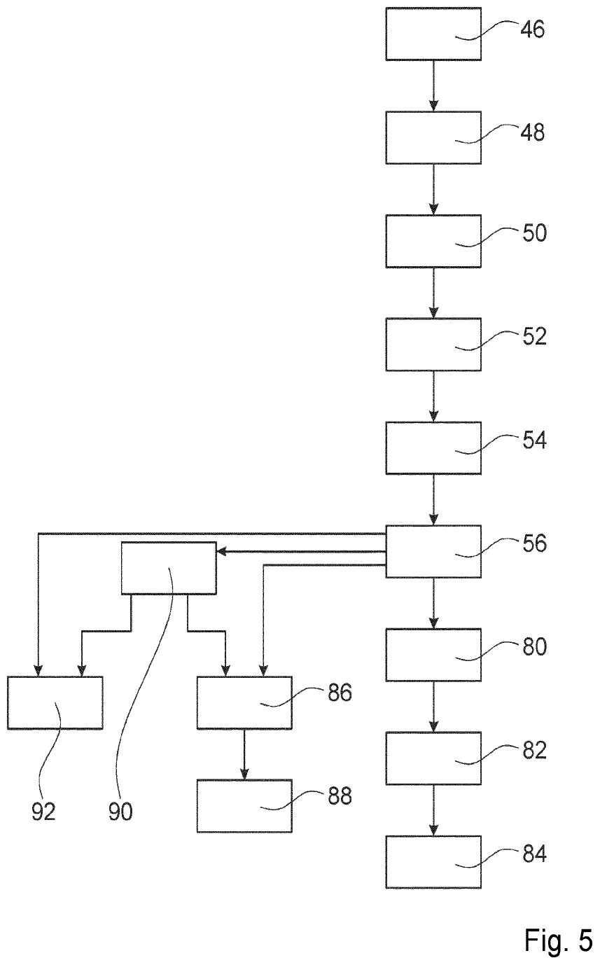

FIG. 5 a schematic flow chart of a method for monitoring a vehicle loading surface of the vehicle.

### DESCRIPTION OF THE EMBODIMENT

FIG. 1 shows a schematic side view of a vehicle 10. The vehicle 10 is designed as a truck. The vehicle 10 can be designed to be autonomously driving. The vehicle 10 comprises a vehicle loading surface 12. The vehicle loading surface 12 is closed. Alternatively, the vehicle loading surface 12 could also be open. The vehicle loading surface 12 delimits a loading space 64 downwards. The vehicle 10 comprises side walls 20. The side walls 20 delimit the loading space 64 to the side. The vehicle 10 comprises a loading space ceiling 66. The loading space ceiling 66 delimits the loading space 64 upwards. The loading space ceiling 66 and/or at least one of the side walls 20 can be formed by a tarpaulin, in particular a sliding curtain. In this case, the vehicle 10 is designed as a so-called tautliner/curtainsider. Alternatively, it is conceivable that the vehicle 10 has a container or has loaded a container, wherein the container forms a container loading surface (not shown). The vehicle loading surface 12 and the container loading surface are configured for receiving/setting up objects 18, in particular goods. The loading space 64 is configured for receiving the objects 18 in an enclosing manner. The vehicle 10 comprises a drive 62. The vehicle 10 comprises an on-board computer 68. The on-board computer 68 comprises a navigation device. Alternatively, it is conceivable that the navigation device is formed separately from the on-board computer 68. In the case of the autonomously driving truck, the navigation device of the on-board computer 68 specifies a driving route. The vehicle 10 comprises a loading surface monitoring device 42. The loading surface monitoring device 42 comprises a load weight sensor 24. The load weight sensor 24 is arranged in the region of an axle 70 of the vehicle 10. The load weight sensor 24 is advantageously designed as a vehicle weighing system integrated into the axle 70 or fastened to the axle 70.

The loading surface monitoring device 42 comprises a radar and/or lidar sensor unit 14. The radar and/or lidar sensor unit 14 is configured for radar monitoring of the vehicle loading surface 12 or for lidar monitoring of the vehicle loading surface 12. The radar and/or lidar sensor unit 14 is configured for installation on the vehicle 10. The radar and/or lidar sensor unit 14 comprises monitoring sensors 40. Each of the monitoring sensors 40 comprises a field of view 28, 36. The fields of view 28, 36 each delimit the (maximum) regions which can be monitored by the individual monitoring sensors 40. The fields of view 28, 36 of the radar and/or lidar sensor unit 14, in particular of the individual monitoring sensors 40 of the radar and/or lidar sensor unit 14, are each oriented from above onto the vehicle loading surface 12. The monitoring sensors 40 of the radar and/or lidar sensor unit 14 are each supported movably. In this case, the monitoring sensors 40 of the radar and/or lidar sensor unit 14 can each be supported translationally movably, for example, along a rail 72 of the vehicle 10 indicated by way of example in FIG. 1. In this case, the monitoring sensors 40 of the radar and/or lidar sensor unit 14 can each be supported pivotably, for example, about a pivot axis extending along the rail 72 or about a vertically oriented pivot axis (see FIG. 3). An immovable fixing of the monitoring sensors 40 in the loading space 64 is, however, of course also conceivable.

The monitoring sensors 40 of the radar and/or lidar sensor unit 14 can be designed as lidar sensors or as radar sensors. However, within the scope of the described invention, the monitoring sensors 40 are preferably designed as ultra-wideband radar sensors 16 (whereby a radar sensor unit is formed from the radar and/or lidar sensor unit 14).

FIG. 2 shows a schematic representation of a portion of the loading surface monitoring device 42 with the radar and/or lidar sensor unit 14 with the monitoring sensor 40. The monitoring sensor 40 is designed as an ultra-wideband radar sensor 16. The ultra-wideband radar sensor 16 is based on M-sequence technology. The ultra-wideband radar sensor 16 operates in a frequency range between 100 MHz and 6 GHz with a bandwidth of at least 500 MHz and/or in a frequency range between 6 GHz and 8.5 GHz with a bandwidth of at least 500 MHz. The ultra-wideband radar sensor 16 is configured for a detection of living beings, in particular humans and/or animals, in the area of the vehicle loading surface 12. The ultra-wideband radar sensor 16 is configured for a detection of movements of the objects 18 located on the vehicle loading surface 12. The ultra-wideband radar sensor 16 is configured for a detection of changes in the side walls 20 delimiting the vehicle loading surface 12. The ultra-wideband radar sensor 16 is configured for a detection of the occurrence of a new opening in at least one of the side walls 20. The ultra-wideband radar sensor 16 is configured for a detection of a slashing of the tarpaulin delimiting the loading space 64, in particular a sliding curtain. The ultra-wideband radar sensor 16 is configured for a detection of free loading surface areas. The loading surface monitoring device 42 is configured to evaluate the measurement data of the ultra-wideband radar sensor 16 for a detection of living beings, for a detection of movement of goods, for a detection of side wall manipulation and/or for a detection of free surfaces and to generate and send corresponding messages and/or warning notifications.

The loading surface monitoring device 42, in particular the monitoring sensor 40 of the radar and/or lidar sensor unit 14, comprises a computing unit 22. The computing unit 22 is configured to evaluate the measurement data of the ultra-wideband radar sensor 16. The computing unit 22 is configured to generate the messages or warning notifications. The loading surface monitoring device 42, in particular the radar and/or lidar sensor unit 14, comprises an accumulator 74. The accumulator 74 is configured to supply power to the monitoring sensor 40 and the components assigned to or subordinate to the monitoring sensor 40. The radar and/or lidar sensor unit 14 comprises a communication module 26. The communication module 26 can be wireless or wired. The communication module 26 is configured to output measurement data of the radar and/or lidar sensor unit 14 and/or notifications (messages and/or warning notifications) determined based on the measurement data of the radar and/or lidar sensor unit 14 to an external receiver 76, in particular to an external receiving and/or playback device 78 of the external receiver 76.

FIGS. 3 and 4 show various further views of the vehicle 10 with the loading surface monitoring device 42. In the example shown, the radar and/or lidar sensor unit 14 comprises four ultra-wideband radar sensors 16, 30, 32, 34. The four ultra-wideband radar sensors 16, 30, 32, 34 are each formed separately from one another. The four ultra-wideband radar sensors 16, 30, 32, 34 are each arranged spaced apart from one another. The fields of view 28, 36 of in each case two of the ultra-wideband radar sensors 16, 30, 32, 34 of the radar and/or lidar sensor unit 14 are oriented opposite one another. The four ultra-wideband radar sensors 16, 30, 32, 34 of the radar and/or lidar sensor unit 14 are arranged relative to the vehicle loading surface 12 such that a connecting line 38 connecting the four ultra-wideband radar sensors 16, 30, 32, 34 forms a rectangle. The four ultra-wideband radar sensors 16, 30, 32, 34 of the radar and/or lidar sensor unit 14 are arranged in a common plane. The four ultra-wideband radar sensors 16, 30, 32, 34 of the radar and/or lidar sensor unit 14 are arranged on the loading space ceiling 66. The loading surface monitoring device 42 comprises alarm devices 58, 60. The loading surface monitoring device 42 comprises a vehicle-internal alarm device 58. The vehicle-internal alarm device 58 is arranged in the loading space 64. In the case shown by way of example, the vehicle-internal alarm device 58 is integrated into the radar and/or lidar sensor unit 14 (see also FIG. 2). The loading surface monitoring device 42 comprises a vehicle-external alarm device 60. The vehicle-external alarm device 60 is formed by way of example as a smartphone which is configured to receive warning notifications or to output warning sounds or the like.

FIG. 5 shows a schematic flow chart of a method for monitoring the vehicle loading surface 12 via a monitoring sensor unit 44 monitoring the vehicle loading surface 12 (see also FIG. 2). The monitoring sensor unit 44 is designed as a radar monitoring sensor unit. The monitoring sensor unit 44 forms part of the loading surface monitoring device 42. The monitoring sensor unit 44 carries out a detection of living beings, a detection of movement of goods, a detection of side wall manipulation and a detection of free surfaces.

In at least one method step 46, the monitoring sensor unit 44 is provided with several ultra-wideband radar sensors 16, 30, 32, 34. In at least one further method step 48, the ultra-wideband radar sensors 16, 30, 32, 34 are installed in or on the vehicle 10. The ultra-wideband radar sensors 16, 30, 32, 34 of the loading surface monitoring device 42 can already be installed during production of the vehicle 10 and/or container or can be retrofitted as a retrofit kit for a vehicle 10 or a container. In at least one further method step 50, the fields of view 28, 36 of the ultra-wideband radar sensors 16, 30, 32, 34 are oriented from above onto the vehicle loading surface 12. In at least one further method step 52, ultra-wideband radar signals are emitted. In at least one further method step 54, reflection signals of the previously emitted ultra-wideband signal are received by the ultra-wideband radar sensors 16, 30, 32, 34. In at least one further method step 56, the reflection signals for detecting living beings, for detecting movement of goods, for detecting side wall manipulation and/or for detecting free surfaces are evaluated. The ultra-wideband radar signals are recurrently emitted and received again at short time intervals (e.g. milliseconds, hundredths of a second or tenths of a second). Alternatively, it is conceivable that the ultra-wideband radar signals are activated only upon request by the external receiver 76.

In at least one further method step 80, a report based on the evaluation of the reflection signals is transmitted to the external receiver 76. In method step 80, a current transport offer and/or a current free transport capacity is transmitted to the external receiver 76 on the basis of the last performed free surface detection. In method step 80, route information associated with the vehicle 10 is additionally transmitted to the external receiver 76. In method step 80, a planned route layout with scheduling is transmitted to the external receiver 76. In at least one further method step 82, a free surface reservation is generated by the external receiver 76 and transmitted back to the vehicle 10 and/or the loading surface monitoring device 42 which has reported the transport offer and/or the free transport capacity. In at least one further method step 84, a route layout, in particular of a navigation device of the vehicle 10, is automatically adapted such that the free surface reservation can be fulfilled. In method step 84, a scheduling of the vehicle 10 is additionally adapted such that the free surface reservation can be fulfilled.

In at least one further method step 86, the vehicle-internal alarm device 58 and/or the external alarm device 60 is controlled, in particular activated, on the basis of the detection of living beings, the detection of movement of goods and/or the detection of side wall manipulation. In at least one further method step 88, the drive 62 of the vehicle 10, in particular of the autonomously driving truck, is blocked on the basis of the detection of living beings on the vehicle loading surface 12. In method step 88, the drive 62 of the vehicle 10, in particular of the autonomously driving truck, is released as soon as no more living beings are detected on the vehicle loading surface 12. In at least one further method step 92, the drive 62 of the vehicle 10, in particular of the autonomously driving truck, is controlled in the case of a detection of a movement of goods, e.g. a slipping or strong shaking of the loaded objects 18. The drive 62 is controlled such that a risk arising from the movement of goods is reduced and/or that a subsequent securing of the objects 18 is made possible.

In at least one further method step 90, an image and/or sound recording is started on the basis of the detection of living beings, the detection of movement of goods and/or the detection of side wall manipulation. In method step 90, an image recording of the detected living beings is taken during the detection of living beings and sent to the outside if applicable. In method step 90, an image recording of the slipped objects 18 is taken during the detection of movement of goods and sent to the outside if applicable. In method step 90, an image recording and/or a sound recording is taken during the detection of side wall manipulation, which records the manipulated side wall 20 and, if applicable, the persons manipulating the side wall 20. If applicable, the recordings for securing evidence are sent to the outside.

1. A loading surface monitoring device with at least one radar and/or lidar sensor unit configured for installation on a vehicle and/or on a container and configured for monitoring a vehicle loading surface and/or a container loading surface.

2. The loading surface monitoring device according to claim 1, wherein the radar and/or lidar sensor unit comprises at least one ultra-wideband radar sensor.

3. The loading surface monitoring device according to claim 2, wherein the ultra-wideband radar sensor is based on M-sequence technology.

4. The loading surface monitoring device according to claim 2, wherein the ultra-wideband radar sensor operates in a frequency range between 100 MHz and 6 GHz with a bandwidth of at least 500 MHz and/or in a frequency range between 6 GHz and 8.5 GHz with a bandwidth of at least 500 MHz.

5. The loading surface monitoring device according to claim 2, wherein the ultra-wideband radar sensor is configured for a detection of living beings, in particular humans and/or animals, in the area of the vehicle loading surface and/or of the container loading surface.

6. The loading surface monitoring device according to claim 2, wherein the ultra-wideband radar sensor is configured for a detection of movements of objects located on the vehicle loading surface and/or on the container loading surface.

7. The loading surface monitoring device according to claim 2, wherein the ultra-wideband radar sensor is configured for a detection of changes in the side walls delimiting the vehicle loading surface and/or the container loading surface, for example for a detection of the occurrence of a new opening in at least one side wall.

8. The loading surface monitoring device according to claim 2, wherein the ultra-wideband radar sensor is configured for a detection of free loading surface areas.

9. The loading surface monitoring device according to claim 5, comprising a computing unit which is configured to evaluate measurement data of the ultra-wideband radar sensor for a detection of living beings, for a detection of movement of goods, for a detection of side wall manipulation and/or for a detection of free surfaces and in particular to generate corresponding messages and/or warning notifications.

10. The loading surface monitoring device according to claim 1, comprising at least one load weight sensor.

11. The loading surface monitoring device according to claim 1, wherein the radar and/or lidar sensor unit comprises a communication module, in particular a wireless or wired communication module, which is configured at least to output measurement data of the radar and/or lidar sensor unit and/or notifications determined based on the measurement data of the radar and/or lidar sensor unit to an external receiver, in particular to an external receiving and/or playback device.

12. The loading surface monitoring device according to claim 1, wherein a field of view of the radar and/or lidar sensor unit, in particular of the ultra-wideband radar sensor, is oriented from above onto the vehicle loading surface and/or the container loading surface.

13. The loading surface monitoring device according to claim 1, wherein the radar and/or lidar sensor unit comprises at least two, preferably at least four, ultra-wideband radar sensors, which are preferably realized separately from one another and arranged spaced apart from one another.

14. The loading surface monitoring device according to claim 13, wherein a field of view of a first ultra-wideband radar sensor of the radar and/or lidar sensor unit is oriented at least substantially opposed to a field of view of a second ultra-wideband radar sensor of the radar and/or lidar sensor unit.

15. The loading surface monitoring device according to claim 13, wherein at least four ultra-wideband radar sensors of the radar and/or lidar sensor unit are arranged relative to the vehicle loading surface and/or to the container loading surface in such a way that a connecting line connecting the four ultra-wideband radar sensors forms a rectangle.

16. The loading surface monitoring device according to claim 1, wherein at least one monitoring sensor of the radar and/or lidar sensor unit, in particular the ultra-wideband radar sensor, is supported movably, in particular translationally movably and/or pivotably.

17. A vehicle, in particular a goods wagon or truck, preferably autonomously driving truck, with an, in particular open or closed, vehicle loading surface or with a container forming a closed container loading surface, and with a loading surface monitoring device according to claim 1.

18. A method for monitoring a vehicle loading surface and/or a container loading surface by means of at least one monitoring sensor unit monitoring the vehicle loading surface and/or the container loading surface, in particular by means of a radar monitoring sensor unit, preferably by means of the loading surface monitoring device according to claim 1, wherein at least one detection of living beings, at least one detection of movement of goods, at least one detection of side wall manipulation and/or at least one detection of free surfaces is carried out by the monitoring sensor unit.

19. The method according to claim 18, comprising at least the method steps:
providing the monitoring sensor unit with one or several monitoring sensors, in particular ultra-wideband radar sensors,
installing the monitoring sensors in or on the vehicle or container,
orienting fields of view of the monitoring sensors from above onto the vehicle loading surface and/or the container loading surface,
emitting a radar or lidar signal, in particular an ultra-wideband radar signal,
receiving a reflection signal of the previously emitted radar or lidar signal, in particular the previously emitted ultra-wideband signal,
evaluating the reflection signal for detecting living beings, for detecting movement of goods, for detecting side wall manipulation and/or for detecting free surfaces,
optionally transmitting a report based on the evaluation of the reflection signal to an external receiver.

20. The method according to claim 18, wherein a transport offer and/or a free transport capacity is transmitted to the external receiver on the basis of the free-surface detection.

21. The method according to claim 20, wherein route information associated with the vehicle or the container, in particular a planned route layout with scheduling, is additionally transmitted to the external receiver.

22. The method according to claim 20, wherein a free surface reservation is transmitted back to the vehicle or to the container which has reported the transport offer and/or the free transport capacity, and in that a route layout and in particular a scheduling of the vehicle or of the container is adapted such that the free surface reservation can be fulfilled.

23. The method according to claim 18, wherein a vehicle-internal and/or container-internal alarm device and/or an external alarm device are/is controlled on the basis of the detection of living beings, the detection of movement of goods and/or the detection of side wall manipulation.

24. The method according to claim 18, characterized in that wherein a drive of the vehicle, in particular of the autonomously driving truck, is controlled, in particular blocked or released, on the basis of the detection of living beings and/or the detection of movement of goods.

25. The method according to claim 18, wherein an image and/or sound recording is started on the basis of the detection of living beings, the detection of movement of goods and/or the detection of side wall manipulation.
